(19) United States
(12) Patent Application Publication
(10) Pub. No.: US 2014/0217007 A1
(43) Pub. Date: Aug. 7, 2014

(54) FILTERING APPARATUS WITH HOLLOW MEMBRANE MODULE FOR DRAINING OFF DEBRIS

(71) Applicant: HSIN TIEN CHIU, New Taipei City (TW)

(72) Inventor: HSIN TIEN CHIU, New Taipei City (TW)

(21) Appl. No.: 13/760,085

(22) Filed: Feb. 6, 2013

(51) Int. Cl. B01D 29/23

(52) U.S. Cl. CPC B01D 29/23
USPC 210/338

(57) ABSTRACT

The present invention provides a filtering apparatus with a hollow membrane module for draining off debris, comprising: an outer shell having a filtering chamber, a water outlet and a first passage; a filter unit inside the filtering chamber of the outer shell and comprising a hollow membrane module and a sleeve mounted on the hollow member module; wherein the sleeve comprises a plurality of through-holes and two end caps attached onto two lateral sides thereof respectively; and a cover on the outer shell and comprising a second passage. Therefore, when the cover is fastened onto the outer shell, the outer shell is clamped onto the two end caps on the filter unit and the perforations of the two end caps arranged corresponding to the first and second passages such that the draining off debris and dirt off the filtering apparatus via either the first or second passage thereof is achieved.

### TECHNICAL FIELD OF THE INVENTION

The present invention is related to a filtering apparatus with a hollow membrane module for draining off debris, in particular, to a filtering apparatus having a water outlet and first and second passages; wherein the water is poured into one of the first passage or second passage during a normal use thereof with the other passage closed in order to guide the water into the filter unit and upon which, it can be filtered through all the micro-perforations formed on the wall of the hollow membrane module, followed by its penetration through all the through-holes of the outer sleeve of the hollow membrane module and finally, to the outside via the water outlet of the outer shell for drinking and uses; furthermore, the present invention is related to a filtering apparatus built for draining off debris and cleaning of the filter unit thereof and during which, one can close the water outlet for drinking and open the first and second passages to allow the pouring in of the water therethrough, allowing the water to pass through the filtering chamber rapidly in order to drain off the debris and dirt accumulated on the filter unit therefrom via the first and second passages such that the objective of providing a filtering apparatus for draining off debris and cleaning thereof is achieved.

### DESCRIPTION OF THE PRIOR ART

It is known that conventional water drinking machines or water filtering and purifying systems mostly utilize hollow membrane articles as a filtering means of the filter units for filtering purposes. It is also known that the hollow membrane articles are effective in filtering out micro debris and objects and are widely used in the field of filtration.

The filtering apparatus with the aforementioned hollow membrane module is commonly known to comprise an outer shell, a filtering chamber provided in the outer shell, a water inlet and a water outlet. The filtering chamber comprises a filter unit made of a hollow membrane, and the filtering unit is arranged between the water inlet and the water outlet. Therefore, as the user pours in the water into the water inlet, the water is filtered by the filtering unit to become clean water after the filtration for further use via the water outlet.

However, after a period of time of use of such known filtering apparatus, the filter unit accumulates debris and dirt, which cannot be cleaned but to be replaced with a new filter unit for sanitization purposes. In other words, such requirement of frequent replacement of the filter units is neither economic nor environmental friendly. There is a need for an improvement to the filtering apparatus.

In view of the aforementioned drawbacks, the inventor seeks to provide a filtering apparatus with a hollow membrane for draining off debris after years of research and development to overcome the drawbacks of known arts.

### SUMMARY OF THE INVENTION

An objective of the present invention is to provide a filtering apparatus with a hollow membrane module for draining off debris, comprising: an outer shell comprising a filtering chamber, a water outlet and a first passage; wherein the filtering chamber is fluidly connected to the water outlet and the first passage; a filter unit provided in an internal the filtering chamber of the outer shell and comprising a hollow membrane module and a sleeve mounted on an external of the hollow member module; wherein the sleeve comprises a plurality of through-holes, and the sleeve comprises two end caps attached firmly on two lateral sides thereof respectively such that the hollow membrane module is clamped between the two end caps; wherein each one of the end caps comprises a perforation; and a cover, fastened onto the outer shell and sealing off an entrance of the filtering chamber, comprising a second passage provided thereon whereby when the cover is fastened onto the outer shell, the outer shell is firmly clamped onto the end caps provided on the two ends of the filter unit and the perforations provided on the two end caps are arranged to be corresponding to the first and second passages in order to achieve the objective of draining off debris and dirt off the filtering apparatus and cleaning thereof.

The present invention is applicable to a conventional household drinking machine, water station, large water filtration and treatment system and water purification system of engineering facilities; however, the present invention is not limited to such applications.

According to an embodiment of the present invention, an end portion of the filtering chamber of the outer shell of the filtering apparatus with a hollow membrane module for draining off debris comprises a protruding edge circumferencing the end portion for attaching firmly to an anti-leakage gasket provided on an end surface of an end cap arranged to be corresponding to an end of the filter unit. In addition, an inner edge of the cover comprises a protruding edge circumferencing the inner edge for attaching firmly to an anti-leakage gasket provided on an end surface of an end cap corresponding to an end of the filter unit such that the water poured into the first passage or the second passage is ensured to be filtered by the hollow membrane module of the filter unit and to penetrate outward through the through-holes on the sleeve provided on the outer most side of the filter unit, upon which it then flows out of the water outlet of the outer shell for drinking with ensured purification.

The main technical features of the present invention rely in at least that the outer side of the filter unit is surrounded by a sleeve comprising a plurality of through-holes formed thereon whereby the water guided into the filtering chamber can flow out of the water outlet of the outer shell during a normal use thereof; and whereby when the filtering apparatus with a hollow membrane module for draining off debris of the present invention has been used for a certain period of time, the water outlet can be closed with the first and second passages being opened to allow a great amount of water to be poured into the hollow membrane module of the filtering chamber in order to drain off the debris and dirt accumulated at the filtering chamber as well as the filter unit to the external of the filtering apparatus via the first passage or the second passage to achieve the objective of draining off debris and cleaning thereof.

### BRIEF DESCRIPTION OF THE DRAWINGS

FIG. 1 is an exploded view of the present invention;

FIG. 2 is a perspective view of the present invention; and

FIG. 3 is a cross-sectional view of the present invention.

### DETAILED DESCRIPTION OF THE PREFERRED EMBODIMENTS

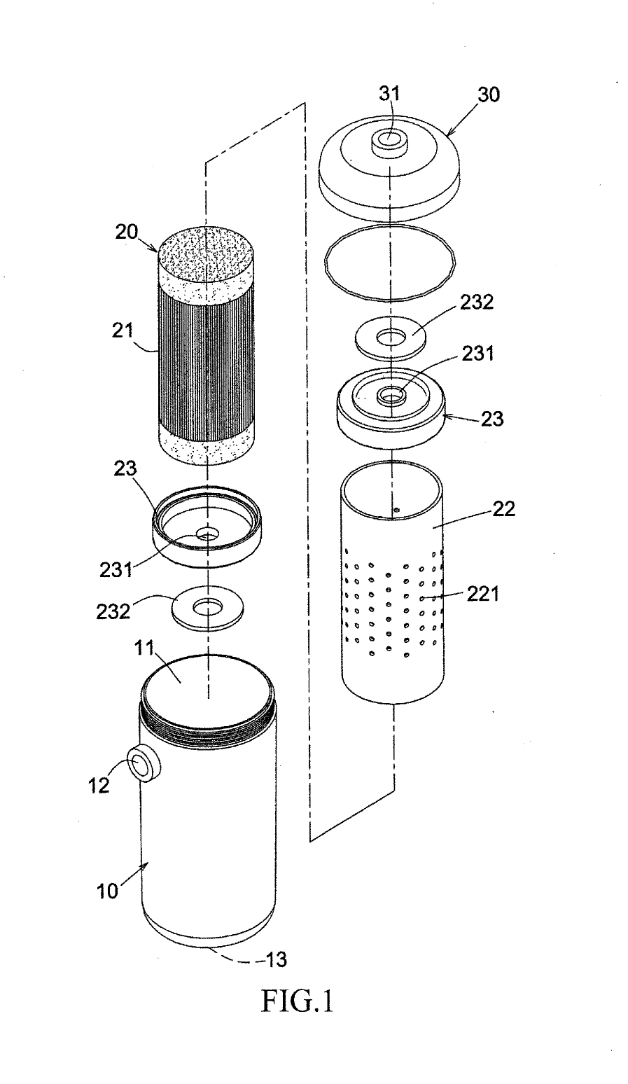

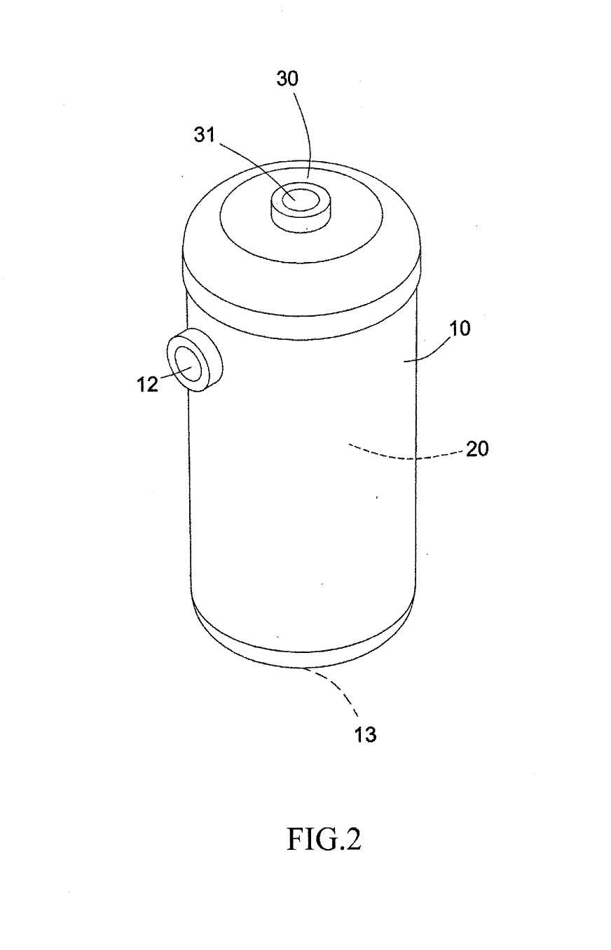

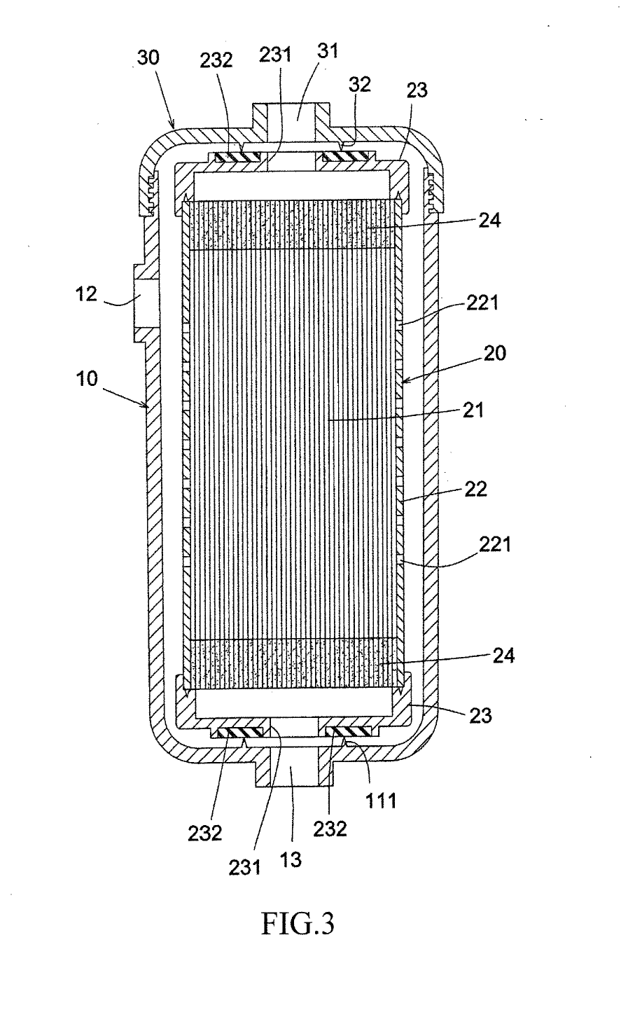

Please refer to FIGS. 1, 2 and 3. As shown in the figures, the present invention provides a filtering apparatus with a hollow membrane module for draining off debris, comprising: an outer shell 10 comprising a filtering chamber 11, a water outlet 12 and a first passage 13; wherein the filtering chamber 11 is fluidly connected to the water outlet 12 and the first passage 13; a filter unit 20 provided in an internal the filtering chamber 11 of the outer shell 10 and comprising a hollow membrane module 21 and a sleeve 22 mounted on an external of the hollow member module 21; wherein the sleeve 22 comprises a plurality of through-holes 221, and the sleeve 22 comprises two end caps 23 attached firmly on two lateral sides thereof respectively such that the hollow membrane module 21 is clamped between the two end caps 23; wherein each one of the end caps 23 comprises a perforation 231; and a cover 30, fastened onto the outer shell 10 and sealing off an entrance 11 of the filtering chamber 11, comprising a second passage 31 provided thereon whereby when the cover 30 is fastened onto the outer shell 10, the outer shell 10 is firmly clamped onto the end caps 23 provided on the two ends of the filter unit 20 and the perforations 231 provided on the two end caps 23 are arranged to be corresponding to the first and second passages 13, 31. Therefore, with such structural, the water can be poured into one of the first passage 13 or the second passage 31 and to close the other passage during a normal use of the filtering apparatus in order to guide the water into the filter unit 20 to be filtered by the hollow membrane module 21 therein, and upon which it can then penetrate through the through-holes 221 of the sleeve 22 and flow out of the water outlet 12 of the outer shell 12 for drinking. Furthermore, when the filtering apparatus of the present invention requires cleaning, one may close the water outlet 12 (such as to turn off the faucet to which the water outlet is connected) and to open the first and second passages 13, 31 in order to allow the water poured therein to drain off the debris and dirt accumulated at the filtering room 11 and filter unit 20 rapidly via the first passage 13 or the second passage 31 to the outside. As an illustrative example, when the first passage 13 is used as a water inlet, the second passage 31 would then be used as a drain off end for cleaning; conversely, if the first passage 13 is used as a drain off end for cleaning, the second passage 31 would then be used as a water inlet. With the aforementioned novel configuration, the objective of the present invention of draining off debris and dirt from the filtering apparatus for cleaning thereof can be advantageously achieved.

The present invention is applicable to a conventional household drinking machine, water station, large water filtration and treatment system and water purification system of engineering facilities; however, the present invention is not limited to such applications.

According to an embodiment of the present invention, an end portion of the filtering chamber 11 of the outer shell 10 of the filtering apparatus with a hollow membrane module for draining off debris comprises a protruding edge 111 circumferencing the end portion for attaching firmly to an anti-leakage gasket 232 provided on an end surface of an end cap 23 corresponding to an end of the filter unit 20. In addition, an inner edge of the cover 30 comprises a protruding edge 32 circumferencing the inner edge for attaching firmly to an anti-leakage gasket 232 provided on an end surface of an end cap 23 corresponding to an end of the filter unit 20 such that the water poured into the first passage 13 or the second passage 31 is ensured to be filtered by the hollow membrane module 21 of the filter unit 20 and to penetrate outward through the through-holes 221 on the sleeve 22 provided on the outer most side of the filter unit 20, upon which it then flows out of the water outlet 12 of the outer shell 10 for drinking with ensured purification.

The outer shell 10 of the present invention can be of any shapes and is not limited any forms and shapes.

In addition, according to the embodiment of the present invention, the filtering apparatus with a hollow membrane module for draining off debris further comprises an adhesive 24 provided between two ends of said hollow membrane module 21 of said filter unit 20 and said sleeve 22 such that the hollow membrane module 21 and the sleeve 22 are secured firmly and such that water leakage from the space between hollow membrane module 21 and the sleeve 22 can be prevented.

The main technical features of the present invention rely in at least that the outer side of the filter unit 20 is surrounded by a sleeve 22 comprising a plurality of through-holes 221 formed thereon whereby the water guided into the filtering chamber 11 can flow out of the water outlet 12 of the outer shell 10 during a normal use thereof; and whereby when the filtering apparatus with a hollow membrane module for draining off debris of the present invention has been used for a certain period of time, the water outlet 12 can be closed with the first and second passages 13, 31 being opened to allow a great amount of water to be poured into the filtering chamber 11 in order to drain off the debris and dirt accumulated at the filtering chamber 11 as well as the filter unit 20 to the external of the filtering apparatus via the first passage 13 or the second passage 31 to achieve the objective of draining off debris and cleaning thereof.

What is claimed is:

1. A filtering apparatus with a hollow membrane module for draining off debris, comprising:
an outer shell comprising a filtering chamber, a water outlet and a first passage; wherein said filtering chamber is fluidly connected to said water outlet and said first passage;
a filter unit provided in an internal said filtering chamber of said outer shell and comprising a hollow membrane module and a sleeve mounted on an external of said hollow member module; wherein said sleeve comprises a plurality of through-holes, and said sleeve comprises two end caps attached firmly on two lateral sides thereof respectively such that said hollow membrane module is clamped between said two end caps; wherein each one of said end caps comprises a perforation; and
a cover, fastened onto said outer shell and sealing off an entrance of said filtering chamber, comprising a second passage provided thereon whereby when said cover is fastened onto said outer shell, said outer shell is firmly clamped onto said end caps provided on said two ends of said filter unit and said perforations provided on said two end caps are arranged to be corresponding to said first and second passages.

2. The filtering apparatus with a hollow membrane module for draining off debris according to claim 1, wherein an end portion of said filtering chamber of said outer shell comprises a protruding edge circumferencing said end portion for attaching firmly to an anti-leakage gasket provided on an end surface of an end cap corresponding to an end of said filter unit.

3. The filtering apparatus with a hollow membrane module for draining off debris according to claim 1, wherein an inner edge of said cover comprises a protruding edge circumferencing said inner edge for attaching firmly to an anti-leakage gasket provided on an end surface of an end cap corresponding to an end of said filter unit.

4. The filtering apparatus with a hollow membrane module for draining off debris according to claim 1, further comprises an adhesive provided between two ends of said hollow membrane module of said filter unit and said sleeve.
